(19) United States
(12) Patent Application Publication
(10) Pub. No.: US 2016/0101727 A1
(43) Pub. Date: Apr. 14, 2016

(54) WARNING METHOD AND APPARATUS OF STATE OF VEHICLE

(71) Applicants: Hyundai Motor Company, Seoul (KR); Kia Motors Corporation, Seoul (KR)

(72) Inventor: Young Min Kwon, Suwon-si (KR)

(21) Appl. No.: 14/685,846

(22) Filed: Apr. 14, 2015

(30) Foreign Application Priority Data
Oct. 10, 2014 (KR) 10-2014-0136645

(51) Int. Cl. B60Q 9/00; B60Q 5/00; B60Q 11/00

(52) U.S. Cl. CPC B60Q 9/00; B60Q 11/00; B60Q 5/005

(57) ABSTRACT

A warning method and apparatus of a state of a vehicle are provided. The method and apparatus promote safety of the vehicle and a driver by detecting a situation (state) in which the safety of the vehicle and the driver is at risk based on various sensors disposed within the vehicle to which a button start-up smart key and an automatic transmission are applied and warning the driver of the situation.

### CROSS-REFERENCE TO RELATED APPLICATION

This application is based on and claims the benefit of priority to Korean Patent Application No. 10-2014-0136645, filed on Oct. 10, 2014 in the Korean Intellectual Property Office, the disclosure of which is incorporated herein in its entirety by reference.

### TECHNICAL FIELD

The present disclosure relates to a warning method and apparatus of a state of a vehicle, and more particularly, to a technology of warning a driver of a situation (state) in which safety of the driver is at risk when the situation is generated within a vehicle to which a button start-up smart key and an automatic transmission are applied.

### BACKGROUND

Recently, a smart key for a vehicle has been used to both open and close vehicle doors and to start the vehicle using a start-up button switch without inserting a key. In this smart key function, the smart key is configured to sense when a driver possessing the smart key approaches the vehicle to thus operate left/right door opening or closing switches, left/right door antennas mounted within a vehicle body of a door handle.

In addition, when the driver possessing the smart key sits on a driver's seat inside the vehicle and then operates the start-up button switch, two indoor antennas are configured to sense the smart key to allow the driver to start the vehicle. Generally, in an automatic transmission vehicle, when the vehicle is started off as a shift lever of an automatic transmission is positioned in a drive mode, even though the driver again starts the vehicle, the shift lever of the automatic transmission is in the drive mode, thus preventing the vehicle from being started.

Therefore, when the automatic transmission vehicle is parked/stopped in the drive mode on a ramp, the vehicle may slide or move downward on the ramp by a load of the vehicle, thus increasing an accident risk.

### SUMMARY

The present disclosure provides a warning method and apparatus of a vehicle state that may promote safety of the vehicle and a driver by determining a situation (state) in which the safety of the vehicle and the driver is at risk based on various sensors disposed within the vehicle to which a button start-up smart key and an automatic transmission are applied and warning the driver of the situation.

Objects of the present disclosure are not limited to the above-mentioned object, and other objects and advantages of the present disclosure that are not mentioned may be understood by the following description and will be more clearly appreciated by exemplary embodiments of the present disclosure. In addition, it may be easily appreciated that objects and advantages of the present disclosure may be realized by means mentioned in the claims and a combination thereof.

According to an exemplary embodiment of the present disclosure, a warning apparatus of a state of a vehicle to which a button start-up smart key and an automatic transmission are applied may include: a start-up sensor configured to sense whether the vehicle is started; a shifting stage sensor configured to sense a shifting stage; a first warning unit configured to output a first warning sound to an inner portion of the vehicle; a door opening or closing sensor configured to sense whether a door is opened or closed; a second warning unit configured to output a second warning sound to an outer portion of the vehicle; and a controller configured to operate the first warning unit to output the warning sound when the vehicle is started when the shifting stage of the vehicle is not a P stage and then operate the second warning unit to output the warning sound when the door of the vehicle is opened.

According to another exemplary embodiment of the present disclosure, a warning apparatus of a state of a vehicle to which a button start-up smart key and an automatic transmission are applied may include: a start-up sensor configured to sense whether the vehicle is started; a shifting stage sensor configured to sense a shifting stage; a warning unit configured to output a warning sound to an outer portion of the vehicle (e.g., extraneous to the vehicle, an outside environment, etc.); a smart key sensor configured to sense a position of the smart key; and a controller configured to operate the warning unit to output the warning sound when the smart key is positioned extraneous to the vehicle in a state in which the shifting stage of the vehicle is a P stage and the vehicle is started.

According to still another exemplary embodiment of the present disclosure, a warning apparatus of a state of a vehicle to which a button start-up smart key and an automatic transmission are applied may include: a start-up sensor configured to sense whether the vehicle is started; a shifting stage sensor configured to sense a shifting stage; a warning unit configured to output a warning sound to an inner portion of the vehicle (e.g., output the warning within the vehicle); and a controller configured to operate the warning unit to output the warning sound when the vehicle is started off when the vehicle is being driven.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary block diagram of a warning apparatus of a state of a vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/controlling unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/controlling unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present disclosure will be described in detail with reference to the accompanying drawings.

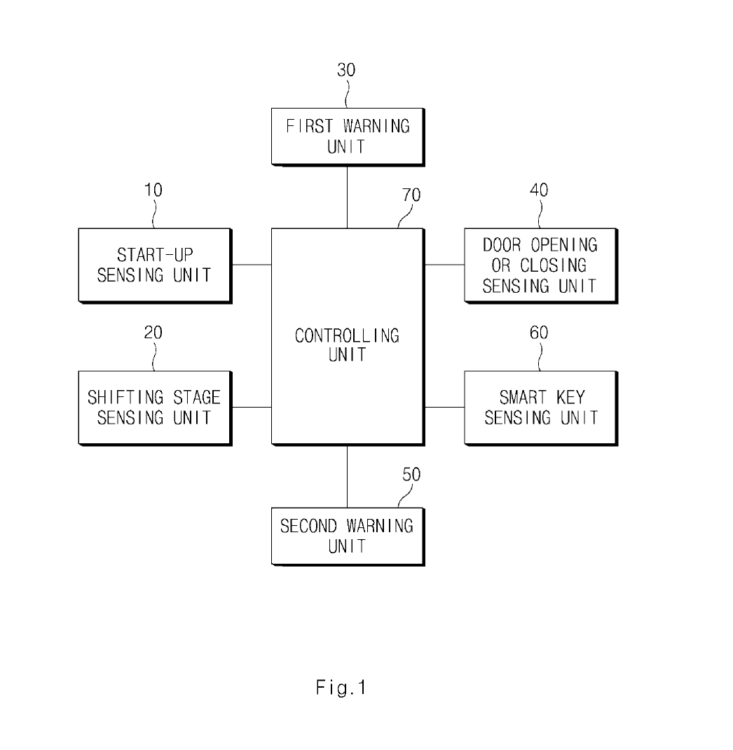

FIG. 1 is an exemplary block diagram of a warning apparatus of a state of a vehicle according to an exemplary embodiment of the present disclosure. As shown in FIG. 1, the warning apparatus of a state of a vehicle according to an exemplary embodiment of the present disclosure may include a start-up sensor 10, a shifting stage sensor 20, a first warning unit 30, a door sensor 40, a second warning unit 50, a smart key sensor 60, and a controller 70. The controller 70 may be configured to operate the start-up sensor 10, the shifting stage sensor 20, the first warning unit 30, the door sensor 40, the second warning unit 50, and the smart key sensor 60.

The respective components described above will be described. The start-up sensor 10 may be configured to sense whether the vehicle is started up or started off. In other words, the start-up sensor 10 may be configured to sense whether the vehicle is started up or started off using an engine tachometer disposed at a cluster of the vehicle. Generally, when a smart key is within the vehicle, when a brake pedal is engaged, and a start-up button is pushed once, the vehicle may be started up. In addition, the start-up sensor 10 may be configured to sense that the vehicle is started off when the start-up button is pushed for a threshold time or longer or is pushed a predetermined number of times within a defined time while the vehicle is being driven.

Furthermore, the shifting stage sensor 20 may be configured to sense a position (e.g., shifting stage) of an automatic transmission lever within an automatic transmission vehicle. In particular, the shifting stage may include a parking stage (P stage), a reverse stage (R stage), a neutral stage (N stage), a driving stage (D stage), and the like. The first warning unit 30, which may be, for example, a device configured to output a sound via a speaker, may be disposed within the vehicle and may be configured to output a first warning sound to the driver within the vehicle. Additionally, the door sensor 40 may be configured to sense whether the door is opened or closed.

Further, the second warning unit 50, which may be, for example, a device configured to output a sound via a speaker, may be disposed within the vehicle and may be configured to output a second warning sound to the driver positioned extraneous to the vehicle under a control of the controller 70. The smart key sensor 60 may be configured to communicate with the smart key to sense whether the smart key is positioned inside or extraneous to the vehicle. In other words, the smart key sensor 60 may be configured to calculate a distance to the smart key to sense whether the smart key is positioned inside or extraneous to the vehicle.

Moreover, the controller 70 may be configured to output the first warning sound via the first warning unit 30 when the vehicle is started off and the shifting stage of the vehicle is not the P stage (e.g., is in the N stage, D stage, or R stage), and then output the second warning sound via the second warning unit 50 when the door of the vehicle is opened. Particularly, the controller 70 may be configured to sense the shifting stage (e.g., the position of the transmission lever) using the shifting stage sensor 20, recognize whether the vehicle is started up or started off using the start-up sensor 10, and recognize whether the door is opened using the door sensor 40. In addition, the controller 70 may be configured to output the second warning sound via the second warning unit 50 when the distance to the smart key exceeds (e.g., is greater than) a threshold distance and the shifting stage of the vehicle is the P stage and the vehicle is started up.

In addition, the controller 70 may be configured to output the first warning sound via the first warning unit 30 in the case in which the vehicle is started off when the vehicle is being driven. Particularly, the controller 70 may be configured to recognize that the vehicle is started off using the start-up sensor 10, and the start-off of the vehicle that is being driven is generated when the start-up button is pushed for a substantial period of time (e.g., 3 seconds) or the start-up button is pushed three times for a shorter period of time (e.g., 1 second or less). In other words, the start-up button is required to be pushed or engaged for a substantial period time (e.g., 3 seconds) or the start-up button is required to be pushed or engaged three times for a shorter period of time (e.g., 1 second or less) to start off the vehicle while the vehicle is being driven.

In the present disclosure, the warning sound may be a sound such as a siren or a melody or may be a speech (e.g., a voice output) such as “a position of a transmission is not a P stage” or “a vehicle is not started off” In the present disclosure, the start-up button may be used when the vehicle is started off in a state in which the vehicle is started up and when the vehicle is started up.

As set forth above, according to exemplary embodiments of the present disclosure, it may be possible to promote the safety of the vehicle and the driver by determining the situation (e.g., state) in which the safety of the vehicle and the driver is at risk based on various sensors indisposed within the vehicle to which a button start-up smart key and an automatic transmission are applied and warning the driver of the situation.

Since the present disclosure described hereinabove may be variously substituted, modified, and altered by those skilled in the art to which the present disclosure pertains without departing from the scope and spirit of the present disclosure, the present disclosure is not limited to the above-mentioned exemplary embodiments and the accompanying drawings.

What is claimed is:

1. A warning apparatus of a state of a vehicle to which a button start-up smart key and an automatic transmission are applied, comprising:
a start-up sensor configured to sense whether the vehicle is started up;
a shifting stage sensor configured to sense a shifting stage;
a first warning unit configured to output a first warning sound within the vehicle;
a door sensor configured to sense whether a door is opened or closed;
a second warning unit configured to output a second warning sound to an outer portion of the vehicle; and
a controller configured to operate the first warning unit to output the first warning sound when the vehicle is started off and the shifting stage of the vehicle is not a P stage and operate the second warning unit to output the second warning sound when the door of the vehicle is opened.

2. The warning apparatus of a state of a vehicle according to claim 1, wherein the shifting stage sensor is configured to sense a position of an automatic transmission lever as the shifting stage.

3. A warning apparatus of a state of a vehicle to which a button start-up smart key and an automatic transmission are applied, comprising:
a start-up sensor configured to sense whether the vehicle is started up;
a shifting stage sensor configured to sense a shifting stage;
a warning unit configured to output a warning sound to an outer portion of the vehicle;
a smart key sensor configured to sense a position of the smart key, and
a controller configured to operate the warning unit to output the warning sound when the smart key is extraneous to the vehicle, the shifting stage of the vehicle is a P stage, and the vehicle is started up.

4. The warning apparatus of a state of a vehicle according to claim 3, wherein the shifting stage sensor is configured to sense a position of an automatic transmission lever as the shifting stage.

5. The warning apparatus of a state of a vehicle according to claim 3, wherein the controller is configured to operate the warning unit to output the warning sound when a distance to the smart key is greater than a threshold distance.

6. A warning apparatus of a state of a vehicle to which a button start-up smart key and an automatic transmission are applied, comprising:
a start-up sensor configured to sense whether the vehicle is started up;
a shifting stage sensor configured to sense a shifting stage;
a warning unit configured to output a warning sound within the vehicle; and
a controller configured to operate the warning unit to output the warning sound when the vehicle is started off while the vehicle is being driven.

7. The warning apparatus of a state of a vehicle according to claim 6, wherein the start-up sensor is configured to sense that the vehicle is started off in the case in which a start-up button is pushed for a threshold period time or longer in a state in which the vehicle is started up.

8. The warning apparatus of a state of a vehicle according to claim 6, wherein the start-up sensor is configured to sense that the vehicle is started off in the case in which a start-up button is pushed a predetermined number of times within a defined time period in a state in which the vehicle is started up.

9. The warning apparatus of a state of a vehicle according to claim 6, wherein the shifting stage sensor is configured to sense a position of an automatic transmission lever as the shifting stage.

10. warning method of a state of a vehicle to which a button start-up smart key and an automatic transmission are applied, comprising:
a memory configured to store program instructions; and
a processor configured to execute the program instructions, the program instructions when executed configured to:
sense whether the vehicle is started up and a shifting stage; output a first warning sound within the vehicle;
sense whether a door is opened or closed;
output a second warning sound to an outer portion of the vehicle;
output the first warning sound when the vehicle is started off and the shifting stage of the vehicle is not a P stage; and
output the second warning sound when the door of the vehicle is opened.

11. The method of claim 10, wherein the program instructions when executed are further configured to sense a position of an automatic transmission lever as the shifting stage.
